(19) United States
(12) Patent Application Publication
(10) Pub. No.: US 2025/0317551 A1
(43) Pub. Date: Oct. 9, 2025

(54) SYSTEM AND METHOD FOR PRE-IDENTIFYING DELAY FACTORS TO MITIGATE PROCESS DELAYS

(71) Applicant: Disney Enterprises, Inc., Burbank, CA (US)

(72) Inventors: Gregory Brooks HALE, Orlando, FL (US); Clifford Aron WILKINSON, Clermont, FL (US); Gary D. MARKOWITZ, San Juan Capistrano, CA (US); Jeremy EATON, Winter Garden, FL (US)

(73) Assignee: Disney Enterprises, Inc., Burbank, CA (US)

(21) Appl. No.: 18/631,035

(22) Filed: Apr. 9, 2024

(51) Int. Cl. H04N 17/00; G06V 10/75; G06V 20/52

(52) U.S. Cl. CPC H04N 17/002; G06V 10/751; G06V 20/52

(57) ABSTRACT

A process improvement platform may receive an indication of a delay in a process and information identifying one or more candidate delay factors associated with the delay; and analyze current video data of the process using a machine learning model trained to identify different candidate delay factors that cause different delays in different processes. The platform may detect, based on analyzing the current video data, the delay and a candidate delay factor of the one or more candidate delay factors and analyze historical video data of the process to determine whether a correlation exists between the candidate delay factor and the delay. The platform may predict, based on analyzing the historical video data, that the candidate delay factor causes delays in the process; and determine, based on predicting that the candidate delay factor causes the delays, an action to be performed to mitigate subsequent delays.

### BACKGROUND

A camera device may be used to capture video data of an environment. The environment may include a warehouse, an airport, and/or a manufacturing plant. The camera device may be used to monitor operations in the environment.

### SUMMARY

A method performed by a process improvement platform, the method comprising: receiving an indication of a delay in a process and information identifying one or more candidate delay factors associated with the delay; analyzing current video data of the process using a machine learning model trained to identify delay factors that cause different delays in different processes; detecting, based on analyzing the current video data, the delay and a candidate delay factor of the one or more candidate delay factors; analyzing historical video data of the process to determine whether a correlation exists between the candidate delay factor and the delay; predicting, based on analyzing the historical video data, that the candidate delay factor causes delays in the process; determining, based on predicting that the candidate delay factor causes the delays, an action to be performed to mitigate subsequent delays to be caused by the candidate delay factor during the process; causing the action to be performed to mitigate the subsequent delays during the process; and monitoring the process to determine whether the subsequent delays, in the process, have been mitigated as a result of causing the action to be performed.

A system comprising: a process improvement platform configured to: analyze current video data of a process using a machine learning model trained to identify delay factors that cause different delays in different processes; detect, based on analyzing the current video data, a delay during the process and a candidate delay factor associated with the delay; analyze historical video data of the process to determine whether a correlation exists between the candidate delay factor and delays during the process; determine, based on analyzing the historical video data, that the correlation exists between the candidate delay factor and the delays during the process; determine a corrective action to be performed to mitigate subsequent delays to be caused by the candidate delay factor during the process; determine whether subsequent delays, in the process, have been mitigated as a result of the corrective action being performed; analyze additional video data of the process using the machine learning model; detect the candidate delay factor based on analyzing the additional video data; and cause the corrective action to be performed based on: the candidate delay factor being detected in the additional video data, and whether the subsequent delays have been mitigated as a result of causing the corrective action to be performed.

A non-transitory computer-readable medium storing a set of instructions, the set of instructions comprising: one or more instructions that, when executed by one or more processors of a device, cause the device to: analyze current video data of a process using a machine learning model; detect, based on analyzing the current video data, a delay during the process and a candidate delay factor associated with the delay; analyze historical video data of the process to determine whether a correlation exists between the candidate delay factor and delays during the process; determine, based on analyzing the historical video data, a corrective action to be performed to mitigate subsequent delays to be caused by the candidate delay factor during the process; and monitor the process to determine whether subsequent delays, in the process, have been mitigated as a result of the corrective action being performed.

### BRIEF DESCRIPTION OF THE DRAWINGS

FIGS. 1A-1F are diagrams of an example implementation described herein.

FIG. 2 is a diagram illustrating an example of training and using a machine learning model in connection with recognizing characteristics of individuals.

FIG. 3 is a diagram of example components of one or more devices of FIG. 1.

FIG. 4 is a flowchart of an example process relating to pre-identifying delay factors to mitigate process delays.

### DETAILED DESCRIPTION

The following detailed description of example implementations refers to the accompanying drawings. The same reference numbers in different drawings may identify the same or similar elements.

Delays may occur during operations in an environment. The environment may include an airport, a warehouse, and/or a theme park. The delays may be caused by various factors that range from individuals in the environment to processes that are part of the operations. For example, in the context of an airport, the delays occur in security lines. The delays may be caused by the process of searching individuals, by the process of providing instructions to individuals (e.g., to remove and place certain items in containers), and/or by a speed at which security agents perform security/screening tasks, among other examples.

In the context of a cellular telephone repair warehouse, the delays occur with respect operations for repairing and shipping cellular telephones. The delays may be caused by errors during the repair process, by errors during the shipping process, and/or by a speed at which repair technicians perform repairs, among other examples. The delays may prevent the warehouse from reaching goals related to a number of cellular telephones repaired and shipped.

Typically, identifying causes for the delays is a challenging task. In some situations, camera devices may be provided in the environment. The camera devices may capture video footage of the operations in the environment. In this regard, an operator may review hours of video footage (provided by computing devices) to attempt to identify the causes for the delays. Reviewing the hours of video footage in this manner is a time-consuming process. Additionally, or alternatively, reviewing the hours of video footage in this manner may consume computing resources of the computing devices displaying the video footage. Additionally, or alternatively, storing the hours of video footage may consume storage resources used to store the video footage.

Additionally, or alternatively, there is so much information provided in a video footage that it remains possible that some information may not be noticed or that more information may be gleaned from the video footage than is possible with current methods. For example, the operator may be unable to properly identify the causes of the delays. Additionally, or alternatively, the operator may identify erroneous causes of the delays.

In some situations, a lean six sigma process improvement may be used to improve the operations in the environment. Additionally, or alternatively, a case study may be used to improve the operations in the environment. However, the lean six sigma process improvement and the case study are time-consuming and expensive. Additionally, or alternatively, identifying causes for the delays and mitigating the delays may be based on human expertise. However, the human expertise may be limited and/or outdated.

Accordingly, a need exists for a system to efficiently identify causes of delays of operations in an environment and mitigate or prevent the delays from occurring. In this regard, implementations described herein solve the technical problem of efficiently identifying causes of delays of operations in an environment and mitigating or preventing the delays from occurring.

Implementations described herein are directed to a technical solution that includes a system that uses the analysis of video data in combination with one or more machine learning models. The combination of the analysis of video and the one or more machine learning models may be used to identify candidate delay factors that may cause delays in a process performed in an environment. The environment may include an airport, a warehouse, and/or a venue, among other examples.

A “candidate delay factor,” as used herein, may refer to a visually observable and quantifiable factor that may correlate with a delay in the process. For example, the “candidate delay factor” may be a hypothesized (or predicted) cause of a delay in the process. A “actual delay factor” (or “delay factor”) as used herein, may refer to a visually observable and quantifiable factor that actually correlates with a delay in the process. For example, the “actual delay factor” may be an actual cause of a delay in the process.

In some situations, an operator (associated with the environment) may identify a parameter relating to the process. In some situations, the operator may be an employee of the airport, of the warehouse, and/or of the venue. The parameter may be a typical amount of time associated with performing the process. The typical amount of time may be an average amount of time, a median amount of time, among other examples. In the context of a security line at an airport, the parameter may be the typical amount of time for conducting a security screening.

In some situations, the system may receive a notification (from a device of the operator) indicating a delay during the process. For example, the operator may have visually observed the delay during the process. Additionally, or alternatively, the system may analyze the video data to detect the delay during the process (e.g., based on the time of completion of the process exceeding the parameter). In the context of the security line at the airport, the process may include conducting a security screening.

Based on the delay being detected and/or based on receiving the notification, the system may cause camera devices in the environment to capture and provide video data of the environment. The system may analyze the video data (e.g., using the one or more machine learning models) to determine that the delay is occurring during the process. Based on determining (or confirming) that the delay is occurring, the system may analyze the video data to detect one or more candidate delay factors.

In some situations, the system may obtain delay factor information identifying historical delay factors previously identified as causes of historical delays in the environment. In some examples, the delay factor information may have been determined by historical information, determined by expert opinion, and/or otherwise determined to be relevant to the task of pre-identifying factors that cause delays in order to mitigate process delays. In this regard, the system may analyze the video data to determine whether one or more of the historical delay factors are detected in the video data.

Based on analyzing the video data, the system may detect a candidate delay factor. The candidate delay factor may be a historical delay factor. The system may quantify and categorize the candidate delay factor. For example, the system may count the quantity of occurrence of the candidate delay factor during a period of time associated with the delay. Additionally, the system may categorize the candidate delay factor. In the context of the security line at the airport, the categories may include a family, an individual wearing an excessive amount of jewelry, an elderly individual, an individual with mobility restrictions (e.g., inability to move, limited mobility, and/or restricted mobility), an inexperienced security agent, and/or a security agent that performs security screening at a speed that is lower than a speed of typical security agents, among other examples. An individual with mobility restrictions may include an individual using a cane, using crutches, carrying a load (e.g., a package), pushing a stroller, among other examples.

The system may predict that the candidate delay factor caused the delay (e.g., based on identifying the candidate delay factor during the delay). In other words, the system may hypothesize that the candidate delay factor caused the delay. The system may test the hypothesis using historical video data of the environment. For example, the historical video data may depict instances of delays during the process and/or instances without delays during the process.

In some examples, the system may analyze the historical video data to test the hypothesis. Continuing with the context of the security line, the candidate delay factor may include an individual wearing excessive jewelry. In this regard, the system may determine whether the instances of delays include individuals with excessive jewelry and/or determine whether the instances without delays did not involve individuals with excessive jewelry.

Based on analyzing the historical video data, the system may confirm the correlation between the candidate delay factor and the delay. For example, the correlation may indicate that individuals wearing excessive jewelry cause delays in security lines. Based on predicting the correlation between the candidate delay factor and the delay, the system may pre-identify (or predict) the occurrence of a delay caused by the candidate delay factor. For example, the system may analyze subsequent video data of the environment to detect the candidate delay factor and may provide a notification (to the device of the operator) indicating the likelihood of a delay based on the candidate delay factor being detected.

The system may provide the notification to cause the operator to take a corrective action (regarding the candidate delay factor) to mitigate delays. For example, the corrective action may include providing instructions (e.g., to remove jewelry) to individuals ahead of time (e.g., prior to reaching a metal detector) to mitigate delays. Additionally, or alternatively, the corrective action may include directing the individual to a separate security line to mitigate delays. In some situations, the separate security line may be a security line dedicated to individuals with a similar amount of jewelry. Additionally, or alternatively, the corrective action may include replacing equipment used to perform the security screening.

In addition to pre-identifying delays, the system may monitor the corrective action to determine whether the corrective action mitigated delays. For example, continuing with the example of the security line, the system may continuously analyze subsequent video data of the environment to determine whether individuals are being screened in accordance with the parameter (e.g., being screened within the amount of time identified by the parameter).

In some situations, based on determining that the corrective action mitigated delays, the system may provide a notification (to the device of the operator) to indicate that the corrective action was successful. Additionally, or alternatively, based on determining that the corrective action mitigated delays, the system may re-determine that the candidate delay factor is an actual delay factor. In other words, the system may re-confirm the hypothesis regarding the candidate delay factor.

In some examples, if the corrective action does not mitigate the delay, the system may determine that the candidate delay factor did not cause the delay (e.g., determine that the hypothesis was not accurate). Accordingly, the system may analyze the video data to determine an alternative candidate delay factor for the delay. In this regard, the system may discard the previously identified candidate delay factor.

Alternatively, if the corrective action does not mitigate delays, the system may analyze additional video data of the environment to determine whether the operator has taken an alternative corrective action (with respect to the candidate delay factor) to mitigate delays. If the alternative corrective action does mitigate delay, the system may determine that the candidate delay factor did in fact cause the delay, thereby re-confirming the hypothesis regarding the candidate delay factor. In some examples, if the alternative action does not mitigate the delay, the system may determine that the candidate delay factor did not cause the delay.

In some situations, the system may analyze additional video data of the environment to detect when the process is not subject to delays and to determine factors that prevented delays from occurring during the process. The factors may include a day of the week, a time of the day, different security lines for different group of people, a timing for providing instructions relating to the security lines, among other examples. The system may provide a notification (to the device of the operator) identifying the factors to cause the operator to implement the factors.

One advantage of the system described herein is that the system is automated and does not rely solely on human expertise. Another advantage of the system described herein is that the system continuously measures and analyzes the process to visually identify candidate delay factors that cause a delay. For example, the system may constantly learn, in real time (or near real time), causes of the delay in the process and may alert the operator in real time (or near real time) to cause the operator to take corrective actions. An additional advantage of the system described herein is that the system may determine correlations between delays and candidate delay factors.

For at least the foregoing reasons, the system described herein is an improvement over existing methods for identifying causes of delays in a process and for taking corrective actions to mitigate delays. By combining the analysis of video and the one or more machine learning models, the system may continuously learn other visual factors (e.g., new candidate delay factors that may lead to delays). The system may be used in various ways, such as ensuring that the goal for an operation is met by constantly measuring and quantifying events as needed. The system enables the process improvement to be automated instead of relying solely on human expertise.

While the example described herein has been provided in the content of a security line at an airport, implementations described are applicable to pre-identifying candidate delay factors during a manufacturing process (e.g., as a product transitions from one step to another step of the manufacturing process), to pre-identifying candidate delay factors during a repair process (e.g., as an item transitions from one step to another step of the repair process); and so on.

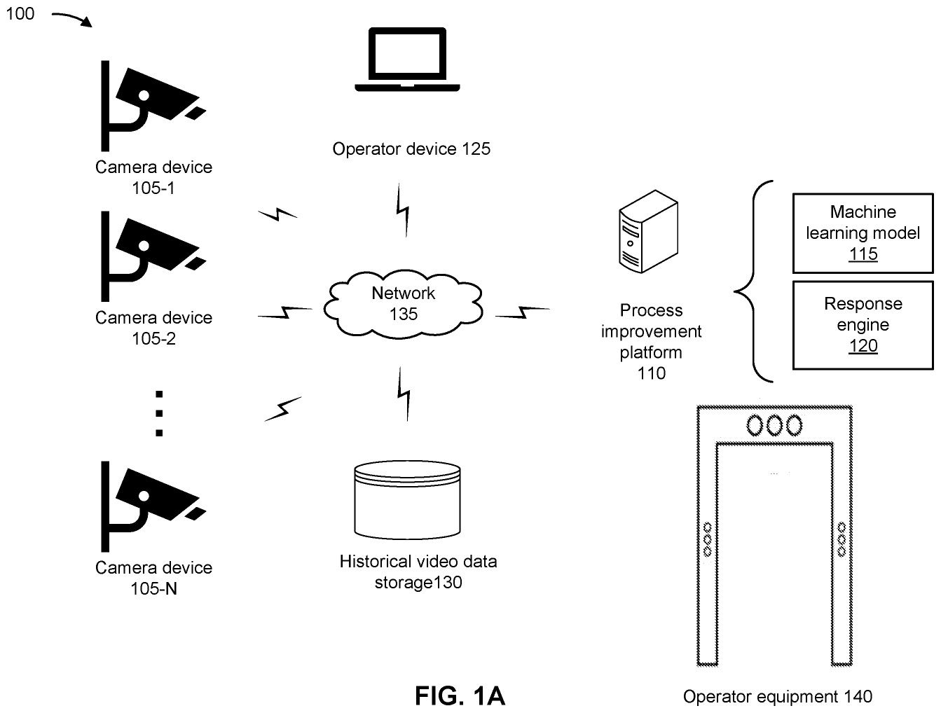

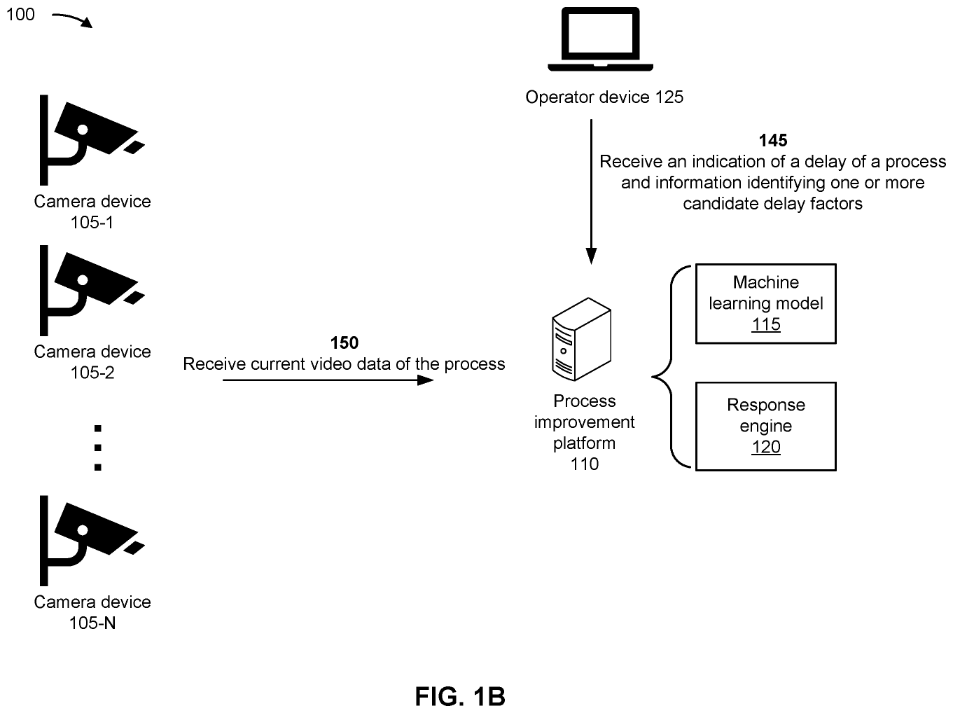

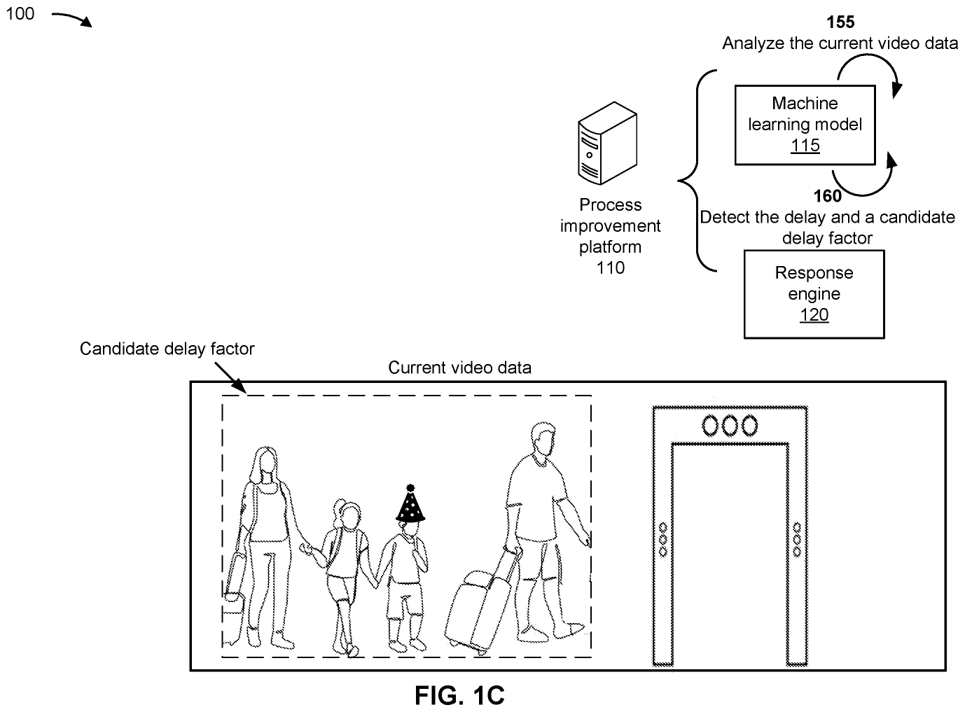

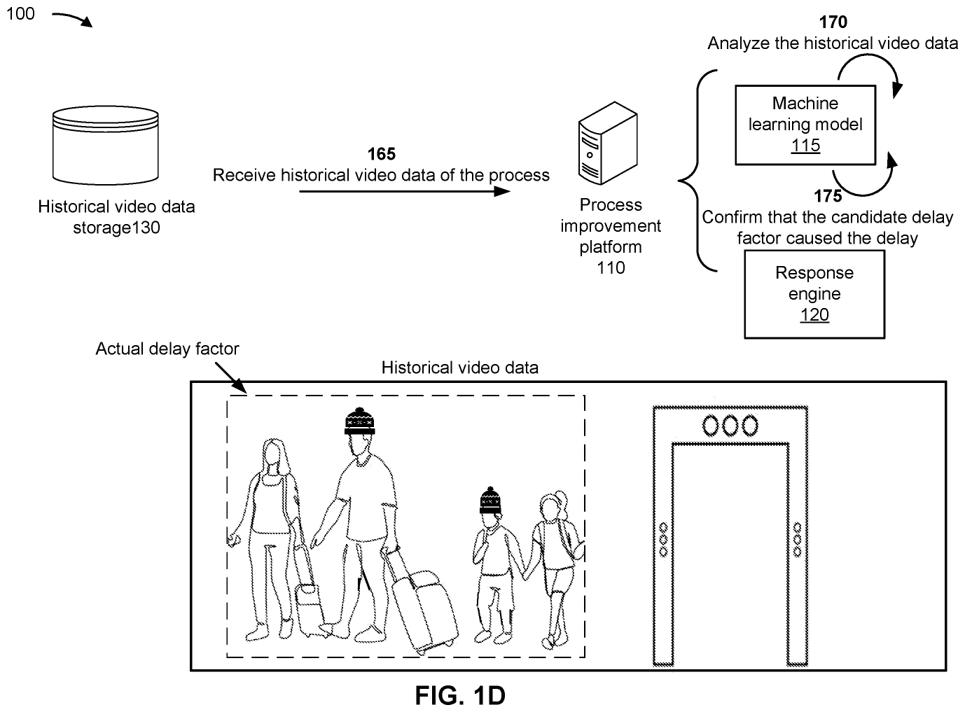

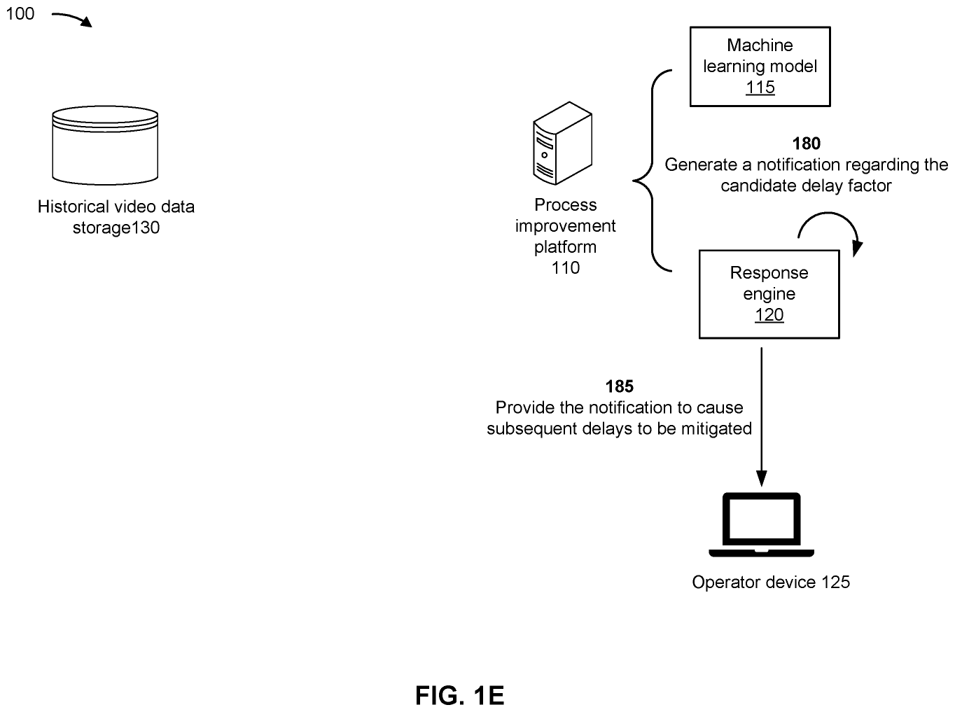

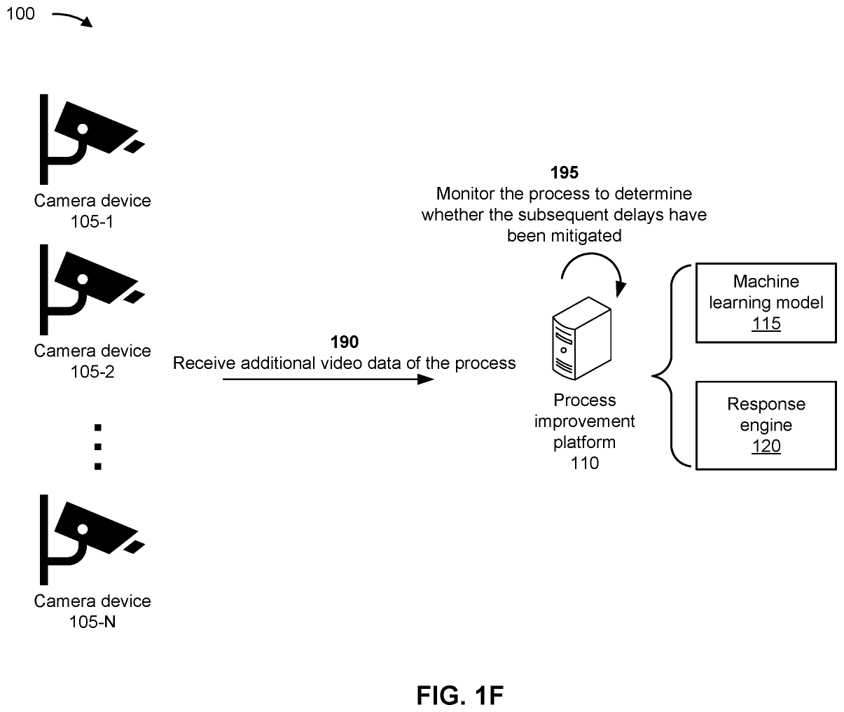

FIGS. 1A-1F are diagrams of an example implementation 100 associated with pre-identifying delay factors to mitigate process delays. As shown in FIGS. 1A-1F, example implementation 100 includes camera devices 105-1, camera device 105-2, to camera device 105-N (collectively camera devices 105 and individually camera device 105), a process improvement platform 110, an operator device 125, a historical video data storage 130, a network 135, and an operator equipment 140.

The devices of FIGS. 1A-1F may be connected via network 135 that includes one or more wired and/or wireless networks. As an example, network 135 may include Ethernet switches. Additionally, or alternatively, network 135 may include a cellular network, a public land mobile network (PLMN), a local area network (LAN), a wide area network (WAN), a private network, the Internet, and/or a combination of these or other types of networks.

Network 135 enables communication between camera devices 105, process improvement platform 110, operator device 125, and/or historical video data storage 130. Camera devices 105, process improvement platform 110, operator device 125, and/or historical video data storage 130 may be part of a system configured to pre-identify delay factors to mitigate process delays s.

A camera device 105 may include one or more devices configured to capture video data of an environment that includes individuals at a venue and/or an establishment. The camera device 105 may provide the video data to process improvement platform 110. In some examples, the camera device 105 may be a monoscopic camera device (or a mono camera device). Alternatively, the camera device 105 may be a stereoscopic camera device (or a stereo camera device). Alternatively, or alternatively, the camera device 105 may be an Internet-of-Things sensor device. Some or all of camera devices 105 may operate in the visible spectrum, infrared spectrum, or ultraviolet spectrum. Likewise, other scene capture technologies such as LIDAR and RADAR may be appropriate for some applications. Imaging technology is chosen to meet the needs of a particular application.

As shown in FIG. 1A, example implementation 100 may include multiple camera devices 105. Camera devices 105 are coupled by wired or wireless connections to process improvement platform 110. Camera devices 105 may provide continuous video/audio streaming or alternatively intermittently stream based on operational needs, triggered programmatically or by motion sensors or other activity triggers.

Process improvement platform 110 may include one or more devices configured to process video data to detect visually observable factors that may cause delays in a process and to pre-identify delays based on the visually observable factors. As an example, process improvement platform 110 may process the video data to identify (or detect) one or more candidate delay factors that potentially cause delays in a process. Process improvement platform 110 may provide information regarding the one or more candidate delay factors to operator device 125 to cause the operator to implement corrective actions to address the one or more candidate delay factors. The corrective actions may mitigate delays in the process.

Processing the video data may include various algorithmic techniques to condition raw video data such that objects and features in the video data are more readily analyzed by later object recognition and machine learning models. This processing may include filtering, adjusting brightness, contrast and color profiles as well as zooming, cropping, rotating and the like. The particular processes chosen and sequence of operations will be adapted to a particular environment and capabilities of camera devices 105.

For example, video from a dark environment may benefit from exposure and contrast enhancement or infrared imagery, while video of a moving vehicle may benefit from rotational translation. In many examples algorithmic feature detection processes are also executed such as edge enhancement and detection processes, corner detection, blob detection, ridge detection and the like are used to as a part of object detection and scene analysis. Example detection techniques include Canny, Deriche, Sobel, Prewitt and/or Roberts edge detection, LoG, DoG, and DoH blob detection, Harris, Shi and Tomasi, level curve curvature corner detection, and Hough transform ridge detection.

As shown in FIG. 1A, process improvement platform 110 may include a machine learning model 115 and a response engine 120. Machine learning model 115 may be a machine learning model trained to detect and/or classify (within an image) different objects that may cause delays during different processes in different contexts. The objects may be determined by historical information, determined by expert opinion, and/or otherwise determined to be relevant to the task of pre-identifying delay factors for different processes in different contexts.

In the context of a security line at an airport, the objects may include accessories and/or articles of clothing, such as jewelry, metal belt buckles, shoes with metal toes and/or metal sole, among other examples. Additionally, or alternatively, the objects may include families, such as large families (e.g., a family with six or more members), families with young children, and/or families with elderly members, among other examples. Additionally, or alternatively, the objects may include individuals with mobility restrictions.

With respect to individuals and families, machine learning model 115 may detect and/or classify body parts, such as a head, a neck, shoulders, elbows, wrists, hips, knees, among other examples. With respect to mobility restrictions, machine learning model 115 may detect and/or classify assistive devices such as crutches, canes, hearing aids, eyeglasses and/or the like, including the reliance of people assisting each other. Machine learning model 115 may be trained to detect and/or classify other objects for different processes in different environments.

Machine learning model 115 may use raw or partially processed video or video frames as input, or may use features (edges, corners, blobs, ridges, and the like) that were identified previously. Machine learning model 115 preferably takes context into account in its training and operation such that it is specifically trained to distinguish between individuals (e.g., heights, body shapes, weight and/or ages), accessories and/or articles of clothing (e.g., jewelry), assistive devices, and/or items that cause delays, in its input.

In some implementations, machine learning model 115 may implement one or more object recognition techniques. For example, machine learning model 115 may detect and/or classify features within the video data, such as individuals, body parts of individuals, accessories, articles of clothing, and/or assistive devices, among other examples. For instance, machine learning model 115 may implement a keypoint detection technique and/or a pose estimation technique, among other examples. Additionally, or alternatively, machine learning model 115 may implement a convolutional neural network (CNN), a Single Shot MultiBox Detector (SSD) technique, and/or a You Only Look Once (YOLO) technique, among other examples.

In some implementations, machine learning model 115 may implement one or more segmentation techniques to distinguish between individuals, body parts of individuals, accessories, articles of clothing, and/or assistive devices. For example, the one or more segmentation techniques may be used to divide an image into different regions based on different characteristics of pixels to identify objects or boundaries. In this regard, machine learning model 115 may implement the one or more segmentation techniques to detect locations of individuals, body parts of individuals, accessories, articles of clothing, and/or assistive devices within an image.

In some implementations, machine learning model 115 may implement one or more keypoint techniques. For example, the one or more keypoint techniques may be used to determine spatial locations or points parts of an object. In this regard, machine learning model 115 may be configured to detect keypoints for individuals, body parts of individuals, accessories, articles of clothing, and/or assistive devices, as discussed herein. The keypoints may be example features that may be detected by machine learning model 115. Other features may include corners, ridges, blobs, and/or edges, among other examples. In some situations, machine learning model 115 may be a deep learning model. In some implementations, the segmentation and the keypoint detection may be performed by one or more additional machine learning models.

In some implementations, machine learning model 115 may be trained using training data that include historical video data of individuals of different ages, individuals of different sizes, individuals of different heights, individuals of different body shapes, individuals of different weights, individuals with different mobility restrictions, different accessories, different articles of clothing, different assistive devices, among other examples. In some implementations, machine learning model 115 may be trained to recognize the individuals and another machine learning model may be trained to recognize accessories, articles of clothing, and/or assistive devices.

Response engine 120 may include one or more devices configured to provide notifications indicating that candidate delay factors have been detect and indicating that corrective actions are to be taken to mitigate delays that may be caused by the candidate delay factors. Additionally, or alternatively, response engine 120 may determine the corrective actions based on the candidate delay factors, the process, and/or the environment and may include information regarding the corrective actions in the notifications.

In some examples, the corrective actions may be implemented manually according to a flowchart, table, or manual of corrective response based on the candidate delay factors, the parameter determined for the process, and/or the environment. Additionally, or alternatively, the corrective actions may be automated using, for example, a lookup table of delay factors, corrective actions, and individual communication or robotic response. Additionally, or alternatively, response engine 120 may automatically send the notifications to a human monitor who then directs further corrective actions.

Operator device 125 may include one or more devices configured to receive information from process improvement platform 110 to facilitate mitigation of delays in processes. Additionally, or alternatively, operator device 125 may be configured to provide (to process improvement platform 110) information indicating that a delay has been visual observed by the operator. In some examples, operator device 125 may be a device of an operator in the environment, a device of an individual that is not an operator, among other examples.

Historical video data storage 130 may include one or more devices configured to store historical video data of the environment. In some examples, the historical video data may be obtained from one or more camera devices 105 located in the environment. The historical video data may be used to confirm whether a correlation exists between a candidate delay factor and a delay. In some implementations, historical video data storage 130 may be implemented as a cloud storage.

Operator equipment 140 may include a device or equipment that is used by an operator to execute a process in the environment. As shown in FIG. 1A, in the context of an airport, operator equipment 140 may include a metal detector. In some situations, operator equipment 140 may include equipment used in a warehouse, equipment used in a factory, equipment used in a venue, among other examples.

As shown in FIG. 1B, and by reference number 145, process improvement platform 110 may receive an indication of a delay of a process and information identifying one or more candidate delay factors. For example, process improvement platform 110 may receive the indication from operator device 125 after the operator visually observes the delay of the process in an environment. For instance, the environment may include an airport and the process may be a security screening. In this regard, the operator may visually observe the delay during the security screening.

Based on visually observing the security screening, the operator may provide the notification to process improvement platform 110. In some situations, the operator may use operator device 125 to provide information identifying one or more candidate delays factors (e.g., one or more factors that may have caused the delay).

In some situations, the operator may use operator device 125 to provide a parameter regarding the process. For example, the operator may use operator device 125 to provide information identifying a typical amount of time associated with performing the process. In the context of the security line at the airport, the parameter may be a typical amount of time for conducting a security screening.

As shown in FIG. 1B, and by reference number 145, process improvement platform 110 may receive current video data of the process. For example, based on receiving the indication, process improvement platform 110 may cause one or more camera devices 105 in the environment to capture the current video data of the environment and may receive the current video data from the one or more camera devices 105 in the environment (e.g., camera device 105-1 and/or camera device 105-2).

In some examples, process improvement platform 110 may receive the current video data as a continuous video feed. Additionally, or alternatively, process improvement platform 110 may receive the current video data periodically (e.g., every second, every ten seconds, every thirty seconds, among other examples). Additionally, or alternatively, process improvement platform 110 may receive the current video data based on a trigger (e.g., based on a request provided by process improvement platform 110 to camera device 105-1).

As explained above, the environment may include an airport. In this regard, the video data may capture individuals traversing operator equipment 140.

As shown in FIG. 1C, and by reference number 155, process improvement platform 110 may analyze the current video data. For example, based on receiving the current video data and/or the indication, process improvement platform 110 may analyze one or more frames of the video data to determine whether the process is being completed within the typical amount of time. In other words, process improvement platform 110 may analyze the current video data to determine whether the process is subject to a delay.

After determining that the process is subject to a delay, process improvement platform 110 may analyze one or more frames of the video data using one or more object recognition techniques to detect the one or more candidate delay factors (e.g., analyze the current video data using machine learning model 115). For example, machine learning model 115 may receive the current video data as input and may provide, as an output, information indicating whether the one or more candidate delay factors have been detected.

In some examples, process improvement platform 110 (e.g., using machine learning model 115) may analyze the video data to recognize individuals, accessories, articles of clothing, and/or assistive devices. In some examples, process improvement platform 110 (e.g., using machine learning model 115) may analyze the video data using the keypoint detection technique (of machine learning model 115) to determine keypoints of individuals, accessories, articles of clothing, and/or assistive devices.

For instance, machine learning model 115 may analyze individual frames of the video data to detect keypoints in each frame of the video frame. For example, machine learning model 115 may analyze a particular frame of the video data to determine (as the keypoints) different parts of the individuals, different accessories, different articles of clothing, and/or different assistive devices.

In some implementations, process improvement platform 110 may analyze the keypoints using the pose estimation technique (of machine learning model 115). As a result of analyzing the keypoints using the pose estimation technique, process improvement platform 110 may determine a pose and/or an orientation of an individual. In some situations, based on the pose and/or the orientation, process improvement platform 110 may determine whether the individual is using a cane, using crutches, among other examples.

Process improvement platform 110 (e.g., using machine learning model 115) may determine an action performed by the individuals based on the pose and/or the orientation of the individuals. In some situations, process improvement platform 110 may analyze the pose and/or the orientation, using the action recognition technique (of machine learning model 115 or another machine learning model), to determine the action. For example, process improvement platform 110 may determine whether the individual is moving using a cane, is moving using crutches, is performing the screening operation, among other examples.

As shown in FIG. 1C, and by reference number 160, process improvement platform 110 may detect the delay and a candidate delay factor (of the one or more candidate delay factors). For example, based on analyzing the video data, process improvement platform 110 may determine that the process is experiencing a delay.

For example, based on analyzing the video data, process improvement platform 110 (using machine learning model 115) may identify the candidate delay factor captured by the video data. As explained herein, machine learning model 115 may be trained to classify objects. Accordingly, based on analyzing the video data, machine learning model may generate (as an output) information that classifies some of the objects in the video data as members of a family (e.g., a family with young children).

In this regard, based on analyzing the video data, machine learning model may generate (as an output) information indicating a family as a candidate delay factor. Therefore, process improvement platform 110 may generate a hypothesis indicating that the family is the cause of the delay. In some situations, if process improvement platform 110 determines that the process is not subject to a delay, process improvement platform 110 may store the current video data as historical video data in historical video data storage 130. In this regard, the historical video data may be used as historical data of the process being completed without delays and may be used to determine whether another candidate delay factor is an actual delay factor.

As shown in FIG. 1D, and by reference number 165, process improvement platform 110 may receive historical video data of the process. For example, based on hypothesizing (or predicting) that the family is the cause of the delay, process improvement platform 110 may obtain the historical video data to confirm whether the candidate delay factor is an actual delay factor (e.g., to confirm whether the family actually caused the delay during the process).

In some implementations, process improvement platform 110 may receive the historical video data in a manner similar to the manner in which process improvement platform 110 receives the current video data. In some situations, the historical video data may depict one or more first instances of delays during the process and/or one or more second instances without delays during the process.

As shown in FIG. 1D, and by reference number 170, process improvement platform 110 may analyze the historical video data. For example, process improvement platform 110 may analyze the historical video data to determine whether the candidate delay factor is an actual delay factor. In other words, process improvement platform 110 may analyze the historical video data to test the hypothesis. Process improvement platform 110 may analyze the historical video data in a manner similar to the manner in which process improvement platform 110 analyzed the current video data.

Continuing with the context of the security line, the candidate delay factor may include a family. In this regard, process improvement platform 110 may determine whether the one or more first instances of delays include families with young children and/or determine whether the one or more second instances without delays did not involve families with young children.

As shown in FIG. 1D, and by reference number 175, process improvement platform 110 may confirm that the candidate delay factor caused the delay. For example, based on analyzing the historical video data, process improvement platform 110 may determine that the candidate delay factor is an actual delay factor. For instance, based on analyzing the historical video data, process improvement platform 110 may determine that delays occurred for all the instances depicting families with young children. Accordingly, process improvement platform 110 may determine that the candidate delay factor is an actual delay factor.

As shown in FIG. 1E, and by reference number 180, process improvement platform 110 may generate a notification regarding the candidate delay factor. For example, based on confirming that the candidate delay factor caused the delay, process improvement platform 110 (e.g., response engine 120) may generate a notification indicating that the candidate delay factor is an actual delay factor. In some situations, after confirming that the candidate delay factor caused the delay, process improvement platform 110 may continue to receive the current video data (e.g., as a stream) and analyze the current video data to identify the candidate delay factor (or now actual delay factor).

Based on identifying the candidate delay factor, process improvement platform 110 may predict that the candidate delay factor will cause subsequent delays in the process. Accordingly, process improvement platform 110 may generate the notification to indicate that the candidate delay factor has been identified and to indicate that a corrective action is to be taken to mitigate the subsequent delays.

As shown in FIG. 1D, and by reference number 185, process improvement platform 110 may provide the notification to cause the subsequent delays to be mitigated. For example, process improvement platform 110 (e.g., response engine 120) may provide the notification to operator device 125 to cause the operator to develop and implement the corrective action. In some instances, response engine 120 may determine the corrective action and include information regarding the corrective action in the notification. As an example, the corrective action may include directing the family to a security line dedicated to similar families (e.g., similar number of members and/or similar ages of children).

As shown in FIG. 1F, and by reference number 190, process improvement platform 110 may receive additional video data of the process. For example, after providing the notification and/or after the corrective action has been implemented, process improvement platform 110 may cause the camera devices 105 to provide additional video data of the process. For instance, process improvement platform 110 may receive (from operator device 125) information indicating that the corrective action has been implemented. Process improvement platform 110 may receive the additional video data in a manner similar to the manner in which the current video data was received.

As shown in FIG. 1F, and by reference number 195, process improvement platform 110 may monitor the process to determine whether any subsequent delays have been mitigated. For example, process improvement platform 110 may analyze the additional video data to determine whether the process is being completed in accordance with the parameter (e.g., being completed with the amount of time specified by the parameter).

In some situations, if the corrective action does not mitigate subsequent delays, process improvement platform 110 may determine that an alternative corrective action is to be implemented. In some situations, if the corrective action and/or the alternative corrective action does not mitigate subsequent delays, process improvement platform 110 may determine that the video data is to be further analyzed to identify an alternative candidate delay factor.

While the foregoing example has been described with respect to the candidate delay factor being a family, the candidate delay factor may include distracted individuals, individuals with body sizes that exceeds a size threshold, and/or equipment that do not function as desired. With respect to the equipment, process improvement platform 110 may be configured to determine that the equipment is to be repaired, replaced, and/or redesigned.

In the context of a venue, process improvement platform 110 may be configured to provide data on how many individuals are moving at a speed that is less than a speed threshold over a period of time, provide data on the number of individuals carrying a load (e.g., bags), provide data on the number of distracted individuals along with the cause of the distraction (e.g., mobile devices), and/or provide data on the number of individuals needing special assistance. Additionally, or alternatively, process improvement platform 110 may configured to determine how long it took for an individual to find a seatbelt, determine how long it took an individual to fasten a seatbelt, and/or collect data regarding difficulties with respect to finding and/or utilizing a seatbelt.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

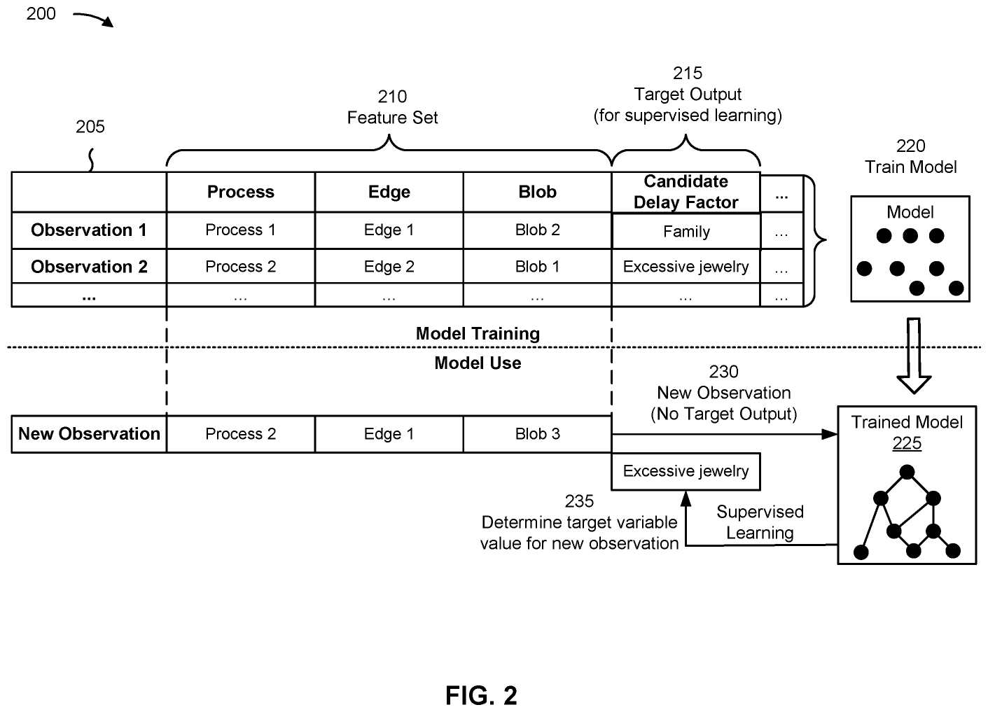

FIG. 2 is a diagram illustrating an example 200 of training and using a machine learning model in connection with pre-identifying delay factors to mitigate process delays. The machine learning model training and usage described herein may be performed using a machine learning system. The machine learning system may include or may be included in a computing device, a server, a cloud computing environment, or the like, such as camera devices 105, process improvement platform 110, and/or operator device 125.

The observations 205 are designed to include examples of various kinds of individuals, accessories, articles of clothing, and/or assistive devices in use by a wide variety of individuals. For example, for individuals to be accurately recognized, observations 205 should include many sizes, shapes, ages, races, genders and the like to ensure unbiased recognition of individuals. Similarly, observations 205 should include many examples of assistive devices such as wheelchairs, canes, mobility scooters, eyeglasses, hearing aids and the like. Similarly, observations 205 should include many examples of accessories and/or articles of clothing, as well as being able to detect when an individual relies on assistance from another individual to be mobile.

As shown by reference number 205, a machine learning model may be trained using a set of observations. The set of observations may be obtained from training data (e.g., historical data), such as data gathered during one or more processes. In some implementations, the machine learning system may receive the set of observations (e.g., as input) from camera devices 105.

As shown by reference number 210, the set of observations may include a feature set. The feature set may include a set of values, and a value may be referred to as a feature. A specific observation may include a set of values. In some implementations, the machine learning system may determine values for a set of observations and/or values for a specific observation based on input received from camera devices 105. For example, the machine learning system may identify a feature set (e.g., one or more features and/or feature values) by extracting the feature set from structured data, by using unsupervised learning techniques to extract the feature set from unstructured data, and/or by receiving input from an operator.

As an example, a feature set for a set of observations may include a first feature set of process, a second feature set of edge, a third feature set of blobs, and so on. As shown, for a first observation, the first feature set is labeled “Process 1,” the second feature set is labeled “Edge 1,” the third feature set is labeled “Blob 2,” and so on. These features sets are provided as examples, and may differ in other examples. Feature set “Process 1” contains data representing features extracted from Observation 1 that pertain to a process performed in an environment. Feature set “Edge 1” contains data representing features extracted from Observation 1 that pertain to the edges of one or more individuals, accessories, articles of clothing, and/or assistive devices. Feature set “Blob 2” contains data representing features extracted from Observation 1 that pertain to the blobs regarding one or more individuals, accessories, articles of clothing, and/or assistive devices. For example, the feature set may include one or more of the following features: environment, corners, ridges, keypoints, location, time of the day, among other examples.

As shown by reference number 215, the set of observations may be associated with a target output. The target output may be represented by a numeric value, may represent a numeric value that falls within a range of values or has some discrete possible values, may represent a value that is selectable from one of multiple options (e.g., one of multiples classes, classifications, or labels) and/or may represent a Boolean value. A target output may be specific to an observation. In example 200, the target output is Candidate Delay Factor, which has a value of “Family” for the first observation. In other words, the first observation may indicate that the candidate delay factor is a family. Accordingly, the machine learning model may be trained, based on the feature set, to classify the observation as a category of candidate delay factor.

The target output may represent an output that a machine learning model 115 is being trained to predict, and the feature sets may represent the inputs used to a train a machine learning model. The set of observations may be associated with target output values so that the machine learning model can be trained to recognize patterns in the feature set that lead to a target output. A machine learning model 115 that is trained using human feedback during training is referred to as a supervised learning model.

In some implementations, the machine learning model 115 may be trained on a set of observations that do not include a target output. This may be referred to as an unsupervised learning model. In this case, the machine learning model may learn patterns from the set of observations without labeling or supervision, and may provide output that indicates such patterns, such as by using clustering and/or association to identify related groups of items within the set of observations. The choice between supervised and unsupervised learning models is determined in a particular instance based on availability of training resources, time, cost, and achieving a desired ability to recognize individuals and objects during operation with sufficient accuracy to meet the needs of a particular application.

As shown by reference number 220, the machine learning system may train a machine learning model using the feature sets 210 extracted from the observations 205 and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model (Trained Model 225) to be used to analyze new observations.

As shown by reference number 230, once trained, the machine learning system may apply Trained Model 225 to a new observation, such as by receiving a new observation and inputting the new observation to Trained Model 225. As shown, the new observation may include a first feature set of “Process 2,” a second feature set of “Edge 1,” a third feature set of “Blob 3,” and so on, as an example. The machine learning system may apply Trained Model 225 to the new observation to generate an output (e.g., a result). The type of output may depend on the type of machine learning model and/or the type of machine learning task being performed. For example, the output may include a predicted value of a target output, such as when supervised learning is employed.

As an example, Trained Model 225 may predict a value of “Excessive jewelry” for the target variable of candidate delay factor for the new observation, as shown by reference number 235. This prediction is temporarily stored along with the location of the individual, preferably only for a time period during which the prediction is useful in providing assistance to an individual. Based on this prediction, response engine 120 may provide a first recommendation, may provide output for determination of a first recommendation, may perform a first automated action, and/or may cause a first automated action to be performed (e.g., by instructing another device to perform the automated action), among other examples. The first recommendation may include, for example, directing the family to a separate security line. The first automated action may include, for example, providing a notification that the family is to be directed to a separate security line.

In this way, the process improvement platform 110 may apply a rigorous and automated process to provide a response to whether an individual has a mobility restriction. The machine learning system enables recognition and/or identification of tens, hundreds, thousands, or millions of features and/or feature values for tens, hundreds, thousands, or millions of observations, thereby increasing accuracy and consistency and reducing delay associated with responding to observable events by human operators manually directing response.

As indicated above, FIG. 2 is provided as an example. Other examples may differ from what is described in connection with FIG. 2.

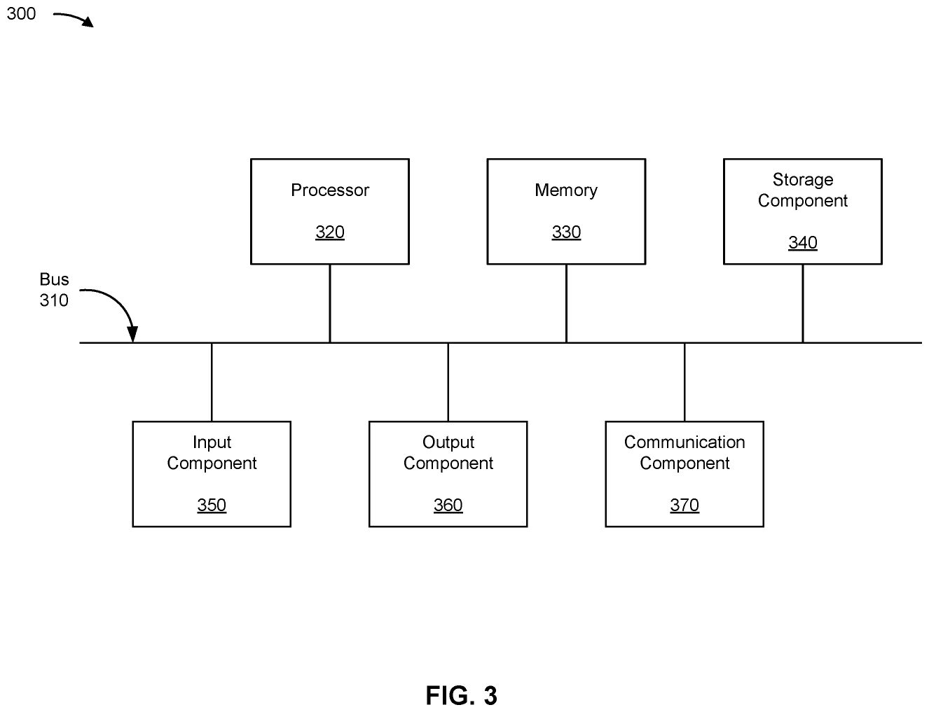

FIG. 3 is a diagram of example components of a device 300, which may correspond to camera devices 105, process improvement platform 110, and/or operator device 125. In some implementations, camera devices 105, process improvement platform 110, and/or operator device 125 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as guest input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

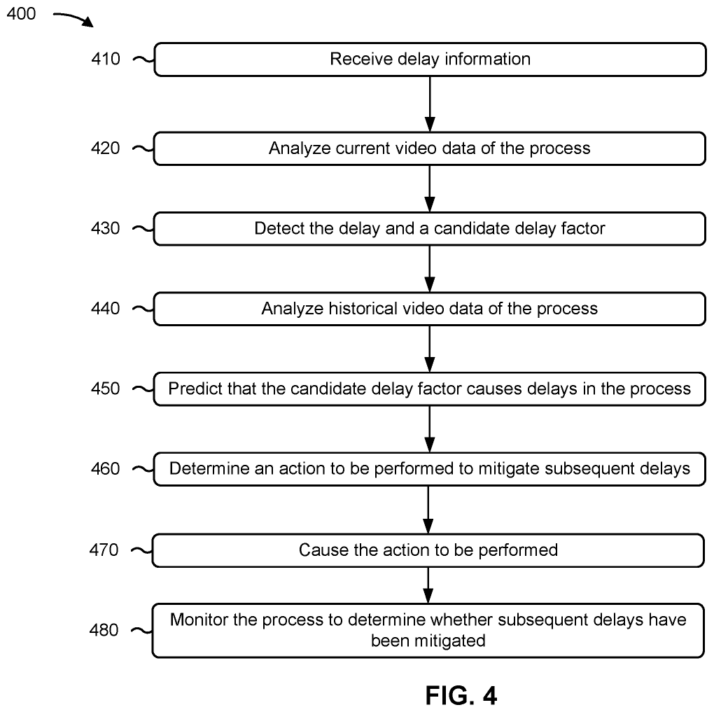

FIG. 4 is a flowchart of an example process 400 relating to pre-identifying delay factors to mitigate process delays. In some implementations, one or more process blocks of FIG. 4 may be performed by a process improvement platform (e.g., process improvement platform 110). In some implementations, one or more process blocks of FIG. 4 may be performed by another device or a group of devices separate from or including the prediction platform, such as a camera device (e.g., camera device 105-1) and/or a client device (e.g., operator device 125). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving an indication of a delay in a process and information identifying one or more candidate delay factors associated with the delay (block 410). For example, the process improvement platform may receive an indication of a delay in a process in an environment and information identifying one or more candidate delay factors associated with the delay. The delay information may be received from a device of an operator as a result of the operator visually observing identifiable delays. Additionally, or alternatively, the delay information may be received from the device of the operator as a result of the operator observing behaviors, processes, and/or mechanical functions to identify common factors that cause a delay.

In some situations, based on receiving the delay information, one or more camera devices 105 may capture and stream video data to video management server in real time. The stream may be routed to a central processing compute server (e.g., the process improvement platform) to be analyzed for any type of visually recognizable delay.

In some implementations, the process improvement platform may receive information identifying a plurality of candidate delay factors that include the candidate delay factor; and select information identifying the candidate delay factor from the information identifying the plurality of candidate delay factors. The information may be selected for analysis in conjunction with the current video data.

As further shown in FIG. 4, process 400 may include analyzing current video data of the process using a machine learning model trained to identify different candidate delay factors that cause different delays in different processes (block 420). For example, the process improvement platform may use one or more machine learning models to analyze the current video data to detect a delay. In some situations, if the process improvement platform does not detect any delay, the process improvement platform may cause the feed/video data to be stored in the historical video data storage.

As further shown in FIG. 4, process 400 may include detecting, based on analyzing the current video data, the delay and a candidate delay factor of the one or more candidate delay factors (block 430). For example, the process improvement platform may use one or more machine learning models to analyze the video data to determine the delays for common factors that lead to the delays. The candidate delay factors may be identified, sorted, totaled, and quantified.

As further shown in FIG. 4, process 400 may include analyzing historical video data of the process to determine whether a correlation exists between the candidate delay factor and the delay (block 440). For example, the process improvement platform may obtain and analyze the historical video data to determine whether the candidate delay factor actually caused the delay. For example, a hypothesis may be made about the candidate delay factor being predictive of a delay. For instance, the process improvement platform may generate a hypothesis indicating that people with excessive jewelry cause delays in security lines. The process improvement platform may evaluate the hypothesis using instance of delays and instances without delays captured by the historical video data. Based on analyzing the historical video data, if the process improvement platform determines that a correlation does not exist between the candidate delay factor and the delay, the process improvement platform may cause the video data to be stored.

As further shown in FIG. 4, process 400 may include predicting, based on analyzing the historical video data, that the candidate delay factor causes delays in the process (block 450). For example, based on analyzing the historical video data, the process improvement platform may determine that a correlation exists between the candidate delay factor and the delay.

As further shown in FIG. 4, process 400 may include determining, based on predicting that the candidate delay factor causes the delays, an action to be performed to mitigate subsequent delays to be caused by the candidate delay factor during the process (block 460). For example, based on determining that the correlation exists, the process improvement platform may determine a corrective action to be performed. The action may be performed to mitigate future delays associated with the candidate delay factor.

In some examples, the process improvement platform may provide, to a device of the operator, remediation information that includes at least one of: information regarding the candidate delay factor, or information regarding a corrective action to mitigate the subsequent delays. The remediation information is provided as part of the corrective action.

As further shown in FIG. 4, process 400 may include causing the action to be performed to mitigate the subsequent delays during the process (block 470). For example, the process improvement platform may cause the operator to implement the corrective action. In some situations, the candidate delay factor may be an individual with a particular body size and/or shape. In this regard, the action may be to identify an accommodation based on the particular body size and/or shape.

As further shown in FIG. 4, process 400 may include monitoring the process to determine whether the subsequent delays, in the process, have been mitigated as a result of causing the action to be performed (block 480). For example, the process improvement platform may analyze additional video data of the environment to determine whether subsequent delays have been mitigated.

In some implementations, the action is a first action, and wherein the method further comprises determining that the subsequent delays are not mitigated as a result of causing the action to be performed, determining a second action to be performed to mitigate the subsequent delays during the process, causing the second action to be performed to mitigate the subsequent delays during the process, and monitoring the process to determine whether the subsequent delays, in the process, have been mitigated as a result of causing the second action to be performed.

In some implementations, the candidate delay factor is a first candidate delay factor, wherein the correlation is a first correlation, and wherein the method further comprises analyzing the historical video data of the process to determine whether a second correlation exists between a second candidate delay factor, of the one or more candidate delay factors, and the delays during the process, determining that the second correlation does not exist, and discarding the second candidate delay factor as a cause of the delays during the process.

In some implementations, process 400 includes determining that the subsequent delays have been mitigated as a result of causing the action to be performed, and determining that the action is to be performed to mitigate future delays associated with the candidate delay factor during the process based on determining that the subsequent delays have been mitigated.

In some implementations, the current video data is video data of the process during a first period of time, and wherein the method further comprises analyzing additional video data of the process using the machine learning model after determining that the subsequent delays have been mitigated, wherein the additional video data is video data of the process during a second period of time that is subsequent to the first period of time, detecting, based on analyzing the additional video data, the candidate delay factor during the second period of time, and causing the action to be performed, based on detecting the candidate delay factor, to mitigate the future delays during the process after the second period of time.

In some implementations, causing the action to be performed comprises predicting, based on detecting the candidate delay factor during the second period of time, that the candidate delay factor will cause the future delays during the process after the second period of time, and causing the action to be performed based on predicting that the candidate delay factor will cause the future delays.

In some implementations, causing the action to be performed comprises providing, to a device, remediation information that includes at least one of information regarding the candidate delay factor, or information regarding a corrective action to mitigate the subsequent delays.

In some implementations, process 400 may include identifying one or more additional delay factors, different than the plurality of candidate delay factors, based on at least one of analyzing at least one of the additional video data or analyzing the historical video data.

In some implementations, process 400 may include analyzing additional video data of the process after determining that the corrective action is to be performed; detecting the candidate delay factor as a result of analyzing the additional video data; predicting additional delays during the process based on detecting the candidate delay factor as a result of analyzing the additional video data; and causing the corrective action to be performed to mitigate the additional delays based on predicting the additional delays.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving an indication of a delay in a process and information identifying one or more candidate delay factors associated with the delay;
analyzing current video data of the process using a machine learning model trained to identify different candidate delay factors that cause different delays in different processes;
detecting, based on analyzing the current video data, the delay and a candidate delay factor of the one or more candidate delay factors;
analyzing historical video data of the process to determine whether a correlation exists between the candidate delay factor and the delay;
predicting, based on analyzing the historical video data, that the candidate delay factor causes delays in the process;
determining, based on predicting that the candidate delay factor causes the delays, an action to be performed to mitigate subsequent delays to be caused by the candidate delay factor during the process;
causing the action to be performed to mitigate the subsequent delays during the process; and
monitoring the process to determine whether the subsequent delays, in the process, have been mitigated as a result of causing the action to be performed.

2. The method of claim 1, wherein the action is a first action, and
wherein the method further comprises:
determining that the subsequent delays are not mitigated as a result of causing the action to be performed;
determining a second action to be performed to mitigate the subsequent delays during the process;
causing the second action to be performed to mitigate the subsequent delays during the process; and
monitoring the process to determine whether the subsequent delays, in the process, have been mitigated as a result of causing the second action to be performed.

3. The method of claim 1, wherein the candidate delay factor is a first candidate delay factor,
wherein the correlation is a first correlation, and
wherein the method further comprises:
analyzing the historical video data of the process to determine whether a second correlation exists between a second candidate delay factor, of the one or more candidate delay factors, and the delays during the process;
determining that the second correlation does not exist; and
discard the second candidate delay factor as a cause of the delays during the process.

4. The method of claim 1, further comprising:
determining that the subsequent delays have been mitigated as a result of causing the action to be performed; and
determining that the action is to be performed to mitigate future delays associated with the candidate delay factor during the process based on determining that the subsequent delays have been mitigated.

5. The method of claim 4, wherein the current video data is video data of the process during a first period of time, and
wherein the method further comprises:
analyzing additional video data of the process using the machine learning model after determining that the subsequent delays have been mitigated,
wherein the additional video data is video data of the process during a second period of time that is subsequent to the first period of time;
detecting, based on analyzing the additional video data, the candidate delay factor during the second period of time; and
causing the action to be performed, based on detecting the candidate delay factor, to mitigate the future delays during the process after the second period of time.

6. The method of claim 5, wherein causing the action to be performed comprises:
predicting, based on detecting the candidate delay factor during the second period of time, that the candidate delay factor will cause the future delays during the process after the second period of time; and
causing the action to be performed based on predicting that the candidate delay factor will cause the future delays.

7. The method of claim 1, wherein causing the action to be performed comprises:
providing, to a device, remediation information that includes at least one of:
information regarding the candidate delay factor, or
information regarding a corrective action to mitigate the subsequent delays.

8. A system, comprising:
a process improvement platform configured to:
analyze current video data of a process using a machine learning model trained to identify delay factors that cause different delays in different processes;
detect, based on analyzing the current video data, a delay during the process and a candidate delay factor associated with the delay;
analyze historical video data of the process to determine whether a correlation exists between the candidate delay factor and delays during the process;
determine, based on analyzing the historical video data, that the correlation exists between the candidate delay factor and the delays during the process;
determine a corrective action to be performed to mitigate subsequent delays to be caused by the candidate delay factor during the process;
determine whether subsequent delays, in the process, have been mitigated as a result of the corrective action being performed;
analyze additional video data of the process using the machine learning model;
detect the candidate delay factor based on analyzing the additional video data; and
cause the corrective action to be performed based on:
the candidate delay factor being detected in the additional video data, and
whether the subsequent delays have been mitigated as a result of causing the corrective action to be performed.

9. The system of claim 8, wherein, to cause the corrective action to be performed, the process improvement platform is further configured to:
determine that the subsequent delays, in the process, have been mitigated as a result of causing the corrective action being performed; and
cause the corrective action to be performed based on:
the candidate delay factor being detected in the additional video data, and
determining that the subsequent delays have been mitigated as a result of causing the corrective action to be performed.

10. The system of claim 8, wherein the process improvement platform is further configured to:
receive information identifying a plurality of candidate delay factors that include the candidate delay factor; and
select information identifying the candidate delay factor, from the information identifying the plurality of candidate delay factors, for analysis in conjunction with the current video data.

11. The system of claim 10, wherein the process improvement platform is further configured to:
identify one or more additional delay factors, different than the plurality of candidate delay factors, based on at least one of analyzing at least one of the additional video data or analyzing the historical video data.

12. The system of claim 8, wherein, to cause the corrective action to be performed, the process improvement platform is further configured to:
provide, to a device of an operator associated with the process, remediation information that includes at least one of:
instructions to implement the corrective action, or
instructions to replace equipment used during the process.

13. The system of claim 8, wherein, to cause the corrective action to be performed, the process improvement platform is further configured to:
determine that the subsequent delays, in the process, have been mitigated as a result of causing the corrective action to be performed; and
determine that the corrective action is to be performed, when the candidate delay factor is detected during the process, based on determining that the subsequent delays have been mitigated.

14. The system of claim 8, wherein the corrective action is a first corrective action, and
wherein the process improvement platform is further configured to:
determine that the subsequent delays have not been mitigated as a result of the first corrective action being performed;
determine a second corrective action;
perform the second corrective action to mitigate the subsequent delays; and
monitor the process to determine whether the subsequent delays have been mitigated as of the second corrective action being performed.

15. A non-transitory computer-readable medium storing a set of instructions, the set of instructions comprising:
one or more instructions that, when executed by one or more processors of a device, cause the device to:
analyze current video data of a process using a machine learning model;
detect, based on analyzing the current video data, a delay during the process and a candidate delay factor associated with the delay;
analyze historical video data of the process to determine whether a correlation exists between the candidate delay factor and delays during the process;
determine, based on analyzing the historical video data, a corrective action to be performed to mitigate subsequent delays to be caused by the candidate delay factor during the process; and
monitor the process to determine whether subsequent delays, in the process, have been mitigated as a result of the corrective action being performed.

16. The non-transitory computer-readable medium of claim 15, wherein the one or more instructions, that cause the device to determine the corrective action, further cause the device to:
determine that the correlation exists between the candidate delay factor and the delays during the process; and
determine the corrective action based on determining that the correlation exists.

17. The non-transitory computer-readable medium of claim 16, wherein the one or more instructions further cause the device to:
determine that the subsequent delays, in the process, have been mitigated as a result of the corrective action being performed; and
determine that the corrective action is to be performed when the candidate delay factor is detected during the process based on determining that the subsequent delays have been mitigated as a result of the corrective action being performed.

18. The non-transitory computer-readable medium of claim 17, wherein the one or more instructions further cause the device to:
analyze additional video data of the process after determining that the corrective action is to be performed;
detect the candidate delay factor as a result of analyzing the additional video data; and
predict additional delays during the process based on detecting the candidate delay factor as a result of analyzing the additional video data.

19. The non-transitory computer-readable medium of claim 18, wherein the one or more instructions further cause the device to:
cause the corrective action to be performed to mitigate the additional delays based on predicting the additional delays.

20. The non-transitory computer-readable medium of claim 15, wherein the one or more instructions further cause the device to:
provide, to a device of an operator associated with the process, remediation information that includes at least one of:
instructions to implement the corrective action, or
instructions to replace equipment used during the process,
wherein the remediation information is provided as part of the corrective action.
